(19) United States
(12) Patent Application Publication
(10) Pub. No.: US 2011/0057145 A1
(43) Pub. Date: Mar. 10, 2011

(54) METHOD FOR PREPARING DENDRIMER-MODIFIED, MAGNETIC FINE PARTICLES

(75) Inventors: Tadashi Matsunaga, Tokyo (JP); Tsuyoshi Tanaka, Tokyo (JP); Keiichi Hatakeyama, Tokyo (JP); Takeo Tanaami, Tokyo (JP); Hitoshi Wake, Tokyo (JP); Tomoyuki Taguchi, Tokyo (JP); Takeyuki Mogi, Tokyo (JP)

(73) Assignees: TOKYO UNIVERSITY OF AGRICULTURE AND TECHNOLOGY, Tokyo (JP); YOKOGAWA ELECTRIC CORPORATION, Tokyo (JP)

(21) Appl. No.: 12/876,562

(22) Filed: Sep. 7, 2010

(30) Foreign Application Priority Data
Sep. 9, 2009 (JP) 2009-207757

(51) Int. Cl. H01F 1/00

(52) U.S. Cl. 252/62.51 R; 977/754

(57) ABSTRACT

There is provided a method for preparing dendrimer-modified magnetic fine particles wherein such particles can be made within a shorter time and more inexpensively than in the above-stated prior art processes and lot-to-lot variations in properties are lessened. The method for preparing dendrimer-fixed magnetic fine particles comprises the steps of providing magnetic particles having a functional group at a surface thereof, providing a dendrimer having a functional group at a base end portion thereof and synthesized to a desired generation and binding the functional group of the magnetic particles and the functional group of the dendrimer directly or indirectly through a crosslinking agent.

### BACKGROUND OF THE INVENTION

1. Technical Field

This invention relates to a method for preparing dendrimer-modified, magnetic fine particles wherein the dendrimer is fixed on the surface of individual particles.

2. Technical Background

In the extraction method of nucleic acids hitherto employed from of old, it has been typical to use phenolic extraction making use of a toxic organic solvent such as phenol or chloroform. In recent years, there have been used, in place thereof, processes wherein a nucleic acid is adsorbed selectively on the surfaces of a silica carrier in the form of silica fine particles or silica membrane filter in a solution containing a high concentration of a chaotropic salt (guanidine hydrochloride, guanidine thiocyanate or the like) (see Vogelstein B., Gillespie D., Proc. Natl. Acad. Sci. USA, 1979, Vol. 76, p. 615-619). This principle enables a nucleic acid to be efficiently purified without use of such a dangerous solvent. Of the processes, the Boom process has been in wide use, in which silica-coated magnetic fine particles are used to permit a nucleic acid to be adsorbed and desorbed through chaotropic reaction (see Boom R., Sol C J., Salimans M M., Jansen C L., Wertheim-van Dillen P M., van der Noordaa J., J. Clinmicrobiol., 1990, Vol. 28., p 495-503). Moreover, there has been developed, as a technique based on a similar principle, a solid-phase reversible immobilization (SPRI) process which makes use of a phenomenon wherein a nucleic acid is bound selectively to magnetic fine particles modified with a carboxyl group in the presence of polyethylene glycol (PEG) (see Hawkins T L., O'Connor-Mortin T., Roy A., Santillan C., Nucleic Acids Res., 1994, Vol. 22, p. 4543-4544). These nucleic acid purification processes making use of magnetic fine particles do not need any operations of centrifugation, filtration, precipitation and the like, thus enabling a high-purity nucleic acid to be extracted and purified in a simple and rapid manner.

However, the Boom process essentially requires the use of irritative, toxic chaotropic salts under high concentration conditions in the nucleic acid adsorption step. Hence, the salt of high concentration is left even after through a washing step, with the possibility that this salt adversely influences subsequent reactions using enzymes, such as of genetic amplification, enzyme cleavage of DNA and the like. Moreover, in the operations of washing magnetic fine particles bound with a nucleic acid, 70% ethanol is employed. It has been pointed out that this ethanol likewise gives an adverse influence. Especially, where a nucleic acid should be handled at a very small reaction volume as with the case of microchip devices, high risk is involved in its incorporation. In the SPRI process, the adverse influences ascribed to the residue of a high concentration salt (NaCl) used in a nucleic acid adsorption step or the incorporation of ethanol in a washing step have become a problem as well.

To cope with these problems, there have been reported isolation techniques of nucleic acids, which make use of charge interaction between the solid phase surface for fixing a nucleic acid thereon and the nucleic acid (see International Laid-open Patent Publication No. 99/29703 and Japanese Laid-open Patent Publication No. 2004-521881 and Weidong Cao et al., Anal. Chem. 2006, Vol. 78, No. 20, P. 7222-7228). Moreover, the DNA extraction kit based on a principle (Charge-Switch technology) substantially same as the isolation technique has been commercially sold. These technologies are ones wherein a nucleic acid in a living body sample is brought into contact with an activated solid phase under certain pH conditions and a negatively charged nucleic acid is electrostatically bound to a positively charged polar group, such as chitosan, introduced at the solid phase surface. Subsequently, the pH of the solution is changed to switch the charge of the solid phase surface from positive to negative, thereby permitting the nucleic acid to be readily desorbed from the solid phase surface. These technologies are excellent in that since no chaotropic salt, high-concentration salt or ethanol is used, adverse influences on safety and also on reactions subsequent to nucleic acid extraction are lessened. Such purification techniques of nucleic acids making use of charges on magnetic fine particles have been expected as being applicable to microdevices. In application to inside microchannels, importance is placed on good dispersability and good magnetic responsiveness. The technique of satisfying them is set forth in Yoza. B et al., J. Biosci. Bioeng. 2003, Vol. 95, No. 1, p. 21-26. More particularly, bacterial magnetic fine particles that have a single-domain structure and thus, are good at magnetic responsiveness although in nanosizes are provided as a core, and a polyamidoamide dendrimer is formed on the surfaces of the fine particles so as to permit the nucleic acid to be bound therewith. The dendritic structure of the dendrimer enables the surface amino group to be fixed at high density. Additionally, it has been elucidated that the fine particles are highly dispersible owing to the mutual surface charge repulsion thereof.

In the method set forth in Yoza. B et al, J. Biosci. Bioeng. 2003, Vol. 95, No. 1, p. 21-25, magnetic fine particles serving as a core are used and stepwise reactions are repeated, thereby realizing high densification of surface amino groups. However, several problems are involved in synthetic processes using conventional cyclic reactions.

Initially, because of a large number of steps before completion of synthesis, a very long time is needed. In case where the sixth-generation reaction accepted as the number of surface amines becomes saturated and the positive charge becomes maximum is carried out, it will take 7 to 10 days. Additionally, since the amounts of reagents required for the synthesis increase and losses of products occur at individual stages, thereby raising costs. Because the reaction efficiencies at the respective stages are varied, the number of surface amino groups on the finally prepared dendrimer magnetic fine particles also varies. This eventually leads to the problem in that performances such as of lot-to-lot variations in properties and dispersability are not stabilized.

### SUMMARY OF THE INVENTION

It is therefore an object of the invention to provide a method for preparing dendrimer-modified magnetic fine particles wherein such particles can be made within a shorter time and more inexpensively than those in the above-stated prior art processes and lot-to-lot variations in properties are lessened.

As a result of intensive studies, we have found that when a dendrimer of a desired generation having a functional group at a base end portion thereof is synthesized beforehand without growth of a dendrimer on magnetic fine particles and is bound directly or indirectly to the surfaces of the magnetic fine particles, a time required for the preparation and costs can be remarkably reduced and lot-to-lot variations in properties can be lessened. The invention has been accomplished based on this finding.

More particularly, the invention contemplates to provide a method for preparing dendrimer-modified magnetic fine particles comprising the steps of:
(1) providing magnetic particles having a functional group at a surface thereof;
(2) providing a dendrimer having a functional group at a base end portion thereof and synthesized to a desired generation; and
(3) binding the functional group of the magnetic particles and the functional group of the dendrimer directly or indirectly through a crosslinking agent.

According to the method of the invention, the dendrimer-modified magnetic fine particles can be prepared within a shorter time and more inexpensively than those in known methods or processes. Without growing a dendrimer on solid-phase magnetic fine particles, a dendrimer that is separately prepared through a liquid-phase reaction can be utilized. The reaction in liquid phase is better in efficiency than those in solid phase and involves no coagulation of fine particles and thus, there is little variation in reaction efficiency. Accordingly, the problem on the variations in reaction efficiency at the respective reaction stages can be avoided unlike reactions on a solid phase. Thus, a lot-to-lot variation of properties is lessened.

### BRIEF DESCRIPTION OF THE DRAWINGS

FIG. 1 is a schematic view showing a reaction scheme of one example of a preparation method adopted in an example of the invention; and

FIG. 2 is a graph showing the relationships among the number of generations of dendrimer-modified magnetic fine particles prepared in the example of the invention, the number of amino groups and the zeta potential.

### EMBODIMENTS FOR CARRYING OUT THE INVENTION

In the method of the invention, magnetic fine particles having a functional group on a surface thereof are initially provided. This step per se is known in the art and is, for example, described in Japanese Laid-open Patent Publication No. 2006-280277. The magnetic fine particles are not critical in type so far as they are those particles, which are capable of being collected by magnetic force and become magnetized and which are able to impart a functional group thereto. Mention is made of magnetic bacteria-derived magnetic fine particles, metal or plastic magnetic fine particles, magnetic beads and the like. The diameter of the magnetic fine particles are not critical and is preferably at about 50 to 100 nm. Of these, magnetic bacteria-derived magnetic fine particles are preferred because they have a single-domain structure and thus are good at magnetic responsiveness although in nanosizes. It is known that the magnetic bacteria have a magnetosome that consists of a sequence of ten to twenty magnetite fine particles having a diameter of about 50 to 100 nm in the bacterial body. The magnetite fine particles can be favorably used in the practice of the invention. The magnetic bacteria known in the art include Magnetospirillum magneticums AMB-1 and MGT-1, Magnetospirillum gryphiswaldense MSR-1, Aquaspirillium magnetotacticum MS-1 and the like. It will be noted that a method for recovering and purifying a nucleic acid by use of an amino group-bearing dendrimer (which will be described hereinafter) using magnetic bacteria-derived magnetic fine particles as a fixation carrier has been already found by us and is now known in the art (see, for example, Japanese Laid-open Patent Publication No. 2009-65849). It will also be noted that although the magnetic bacteria-derived magnetic fine particles have a lipid bilayer, a difficulty is involved in covalent bonding of a dendrimer thereto. Hence, it is preferred to remove the bacteria-derived lipid bilayer by acting thereon a surface active agent such as 1% sodium dodecylsulfate (SDS) or the like, an organic solvent, a strong alkali, or the like.

The functional group on the surface of the magnetic fine particles may be one that is able to bind to a dendrimer or a crosslinking agent described hereinafter and is preferably an amino group. In order to permit an amino group to be attached to the magnetic bacteria-derived magnetic fine particles, the fine particles can be subjected, on the surface thereof, to aminosilane treatment with a known aminosilane coupling agent or an aminosilylation agent. Preferred examples of the aminosilane coupling agent include amino group-containing silane derivatives such as 3-[2-[(2-aminoethyl)-ethylamino]-propyltrimethoxysilane (AEEA) and the like. In case where the aminosilane treatment is performed on the surface of the particles by application of the aminosilane coupling agent, it is preferred that the hydroxyl groups existing in the particles are allowed to be exposed to surfaces. For instance, where the magnetic bacteria-derived magnetic fine particles are used as the particles, the bacteria-derived lipid bilayer existing on the surfaces of the particles are removed for the aminosilane treatment thereby activating the surface hydroxyl group. Eventually, an amino silylation reaction and an aminosilane coupling reaction can be facilitated. One instance of specific reaction conditions is described in detail in examples appearing hereinafter.

On the other hand, a dendrimer having a functional group at a base end portion and prepared to an extent of a desired generation is provided. The dendrimer is a dendritic polymer and has such excellent properties that when a desired type of functional group is incorporated into the polymer, a number of the desired functional groups capable of being fixed per unit area of a carrier can be significantly increased, and has thus been widely studied. As will be described hereinafter, in order to recover and purify a nucleic acid by use of the fine particles of the invention, it is preferred that the dendrimer is positively charged and has an amino group. More preferably, a poly(amidoamine) (PAMAM) dendrimer is used. The PAMAM dendrimer per se is known in the art (see, for example, Japanese Laid-open Patent Publication No. 2004-150797) and is usually made of a branched structure consisting of a core (whose carbon atoms are usually at 2 to 12 in number) of an alkyldiamine (for which there may be used one wherein part of carbon atoms is replaced by a sulfur atom like cystamine) and a tertiary amine. For the PAMAM dendrimer, there are commercially sold dendrimers of various generations using different types of cores (the generation means one as corresponding to what number of branches from a core and is controlled by the number of reaction cycles for branch growth). In the practice of the invention, such commercially sold PAMAM dendrimers can be favorably used. We have already proposed dendrimer-modified magnetic fine particles wherein a PAMAM dendrimer has been fixed on the surfaces of magnetic fine particles and also a method for extracting nucleic acids or proteins by using the particles and filed for an application (i.e. Japanese Laid-open Patent Publication No. 2004-150797). With PAMAM dendrimers, it has been found that the number of amino groups, existing at the end terminal of the branch, per unit area becomes maximum at the sixth generation (see Yoza. B et al., J. Biosci. Bioeng. 2003, Vol. 95, No. 1, p. 21-26., and examples appearing hereinafter). Hence, it is most preferred to use a dendrimer of the sixth generation although dendrimers of other generations may also be used.

The functional group at the base end portion (i.e. a basal portion more than an initial branch of dendrimer) may be one which is able to bind to other functional group and is preferably a thiol group. The dendrimer having a thiol group at the base end portion is preferred because the dendrimer having a thiol group at the base end portion can be readily prepared by making use, as a core, of a diamine having an S—S bond like cystamine, preparing to a desired generation, and treating the resulting dendrimer with a reducing agent such as dithiothreitol to cut off the S—S bond. Since dendrimers of various generations using cystamine as a core have been commercially sold, commercially available dendrimers can be conveniently used. It will be noted that a dendrimer wherein its core is cut off is also called dendron and may be sometimes called dendron in this specification and drawings. In the specification and claims of this application, the term “dendrimer” means as including dendron except the case where it will be proved otherwise by the context.

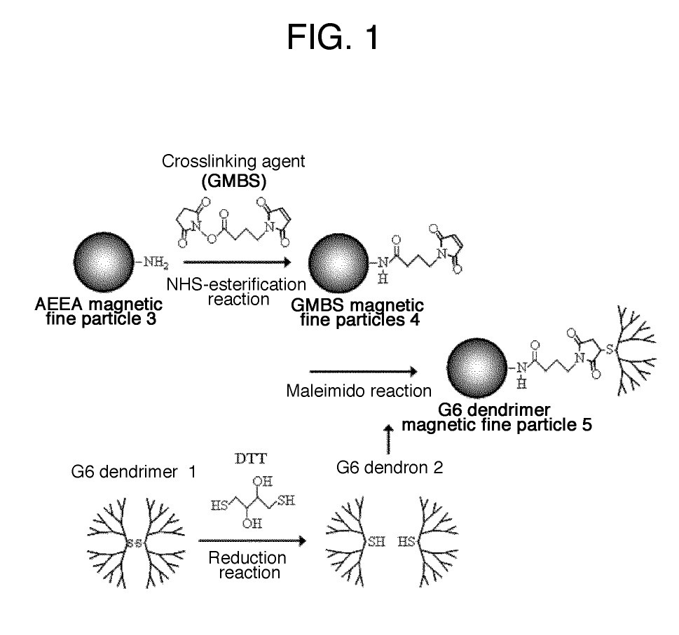

Next, the above-mentioned magnetic fine particles are bound to the dendrimer. This binding may be direct binding of above-mentioned functional groups. It is easy and convenient to perform indirect binding through a crosslinking agent having functional groups capable being bound to the respective functional groups. In a preferred embodiment, as having set forth hereinbefore, the functional group on the surfaces of the magnetic fine particles is an amino group, and the functional group at the base end portion of the dendrimer is a thiol group. In this case, usable crosslinking agents may be ones that have a functional group capable of binding to the amino group and a functional group capable of binding to the thiol group, respectively. Preferably, the functional group binding to the amino group is a hydroxysuccinimidyl ester group and the functional group binding to the thiol group is a maleimido group. Examples of such a crosslinking agent include N-(4-maleimidobutyryloxy)succinimide (GMBS) (see FIG. 1).

Although the reactions among the magnetic fine particles, crosslinking agent and dendrimer may be carried out sequentially or simultaneously, sequential reactions are preferred in view of reaction efficiency. The reaction between the magnetic fine particles and a crosslinking agent can be carried out in an aqueous buffer solution such as a phosphate buffer solution (PBS) generally at 10° C. to 40° C., preferably at room temperature, for 30 minutes to 2 hours, preferably about 40 to 80 minutes. The concentration of the magnetic fine particles is generally at about 0.2 mg/ml to 1.0 ml/ml, preferably at about 0.4 mg/ml to 0.6 mg/ml, and the concentration of the crosslinking agent is generally at 0.5 mM to 2 mM, preferably at about 0.8 mM to 1.2 mM. The reaction is preferably carried out while dispersing the magnetic fine particles by ultrasonic waves.

The subsequent reaction with a dendrimer can be carried out in an aqueous buffer solution such as a phosphate buffer solution (PBS) generally at 10° C. to 40° C., preferably at room temperature, generally for about 30 minutes to 2 hours, preferably for about 40 minutes to 80 minutes. The concentration of the crosslinking agent-bound magnetic fine particles is generally at about 0.2 mg/ml to 1.0 mg/ml, preferably at about 0.4 mg/ml to 0.6 mg/ml and the concentration of the dendrimer is generally at about 0.01 mM to 0.02 mM, preferably at about 0.005 mM to 0.015 mM. The reaction is preferably carried out while dispersing the magnetic fine particles with ultrasonic waves.

According to the above steps, there can be obtained magnetic fine particles wherein the dendrimer is fixed on the surfaces thereof. The magnetic fine particles are preferably washed with an aqueous buffer solution, such as PBS, prior to use.

The dendrimer-modified magnetic fine particles of the invention can be used for recovery and purification of nucleic acids or proteins just in the same manner as known dendrimer-modified magnetic fine particles set forth in the afore-indicated Japanese Laid-open Patent Publication Nos. 2004-150797 and 2009-65849. If the dendrimer used is positively charged in water preferably as having an amino group or the like, a nucleic acid such as DNA or RNA, which is negatively charged in water, can be adsorbed on the magnetic fine particles by utilizing the electrostatic interaction therebetween. More particularly, a nucleic acid can be recovered from a nucleic acid-containing solution by bringing the magnetic fine particles of the invention into contact with the nucleic acid-containing solution to permit the nucleic acid to be adsorbed on the dendrimer and collecting the nucleic acid-adsorbed magnetic fine particles by magnetic force. The nucleic acid-containing solution includes, for example, any of solutions containing materials related to various types of organisms, such as cultured cells, animal-derived calls or tissues (such as blood, serum, buffy coat, fluid, lymphocyte and the like), plant-derived cells or tissues, bacteria, fungi, viruses and the like. The amount of the magnetic fine particles brought into contact with the nucleic acid-containing solution may be appropriately set depending on the expected concentration of the nucleic acid and the amount of the nucleic acid intended for recovery and is generally at about 0.1 mg/ml to 1.0 mg/ml. The adsorption reaction may be effected at room temperature generally for a time of about 30 seconds to 5 minutes. The magnetic fine particles may be placed in microchannels to adsorb a nucleic acid.

The nucleic acid-adsorbed magnetic fine particles can be collected according to a usual manner using a magnetic force.

When the nucleic acid is desorbed from the collected magnetic fine particles, the nucleic acid can be purified. The desorption methods are known in the art as set forth in the afore-indicated Japanese Laid-open Patent Publication Nos. 2004-150797 and 2009-65849 and are performed by thermal treatment, surface active agent treatment or a treatment with a desorbing agent containing a phosphoric group. The thermal treatment conditions may generally include a temperature of about 70 to 90° C. and a time of about 10 to 30 minutes. The surface active agents used include sodium dodecylsulfate, Triton X-100 (commercial name), Tween 20 (commercial name) and the like. The concentration upon use is generally at about 0.01 wt % to 1 wt %. The desorbing agent containing a phosphoric group includes a deoxyribonucleoside diphosphate such as ADP or the like, and a deoxyribonucleoside triphosphate such as ATP or the like. The concentration upon use is generally at about 1.0 mM to 500 mM and the agent is favorably used in co-existence of a low concentration organic solvent such as ethanol.

The nucleic acid desorbed from the magnetic fine particles can be used for an intended purpose and can, of course, be amplified by subjecting to a nucleic acid amplification process such as a PCR or the like. In this case, the desorbing step is carried out in a reaction solution of PCR and the nucleic acid amplification process may be carried out in the presence of the magnetic fine particles from which the nucleic acid has been desorbed.

The invention is more particularly described by way of examples, which should not be construed as limiting the invention thereto.

### Example 1

### Preparation of Magnetic Fine Particles

According to the reaction scheme shown in FIG. 1, dendrimer-modified magnetic fine particles were prepared.

Initially, a dendron to be bound to fine particles was prepared. 400 μl of DTT adjusted to 0.5 mM with PBS was added to 100 μl of a methanol solution of 0.5 mM of G6 dendrimer (a commercial product, PAMAM dendrimer, cystamine core, sixth generation) 1. Thereafter, while agitating, the mixture was incubated at room temperature for 12 hours to reduce the cystamine core, thereby providing G6 dendron 2. The thiol group becomes reactive upon cleavage of the cystamine.

Next, magnetic fine particles wherein a maleimido group reacting with the thiol group was exposed were prepared. Magnetic bacteria (Magnetospirillum magnetium AMB-1) were isolated and prepared according to a conventionally known procedure, followed by removing a lipid bilayer membrane from the surface of individual magnetic particles (average particle size of 80 nm) (see Biotechnology and Bioengineering; Volume 94, Issue 5, pages 862 to 868 (2006)). More particularly, the lipid bilayer membrane present on the surface of individual magnetic particles was removed from the magnetic fine particles with a 1% SDS solution. After washing three times with distilled water, 20 ml of an ammonium peroxide solution (H₂O:H₂O₂:NH₃=5:1:1) was added, followed by dispersion with ultrasonic waves and allowing to stand for 10 minutes to activate the hydroxyl group on the surface of the magnetic fine particles. The magnetic fine particles washed three times with anhydrous methanol were reacted with an ethanol solution of 2% AEEA for 10 minutes under ultrasonic dispersion. The magnetic fine particles obtained after the reaction were washed three times with methanol. After washing once with DMF, the particles were treated in DMF at 120° C. for 30 minutes to permit the silane coupling to be stabilized thereby obtaining AEEA magnetic fine particles 3.

N-(4-Maleimidobutyryloxy)succinimide GMBS) having a hydroxysuccinimidyl ester group reactive with the amino group existing on the surface of the AEEA magnetic fine particles and a maleimido group was used as a crosslinking agent. 1 mM of GMBS prepared by use of PBS was added to the AEEA magnetic fine particles so as to make a concentration of the fine particles at 0.5 mg/ml, followed by reaction at room temperature for 1 hour while dispersing the fine particles by application of ultrasonic waves, thereby preparing GMBS magnetic fine particles 4. The G6 dendron was subjected to tenfold dilution with PBS (dendron concentration: 0.02 mM) and was so added that the concentration of the fine particles relative to the GMBS-modified magnetic fine particles was at 0.5 mg/ml. While dispersing the fine particles by ultrasonic waves, reaction was continued at room temperature for 1 hour, followed by washing three times with anhydrous methanol to prepare G6 dendrimer magnetic fines particles 6.

### Example 2

### Evaluation

The properties of the thus prepared G6 dendrimer magnetic fine particles were evaluated. Simultaneously, magnetic fine particles prepared by use of commercially available dendrons of the generations other than G6 were likewise evaluated. The quantitative determination of the amino group on the surface of the respective fine particles was made according to the procedure set forth below. 200 μl of a sulfo-LC-SPDP solution adjusted to 10 mM by means of PBS was added to 250 μg of magnetic fine particles, followed by reaction for 30 minutes under light-shielded conditions while subjecting to ultrasonic dispersion in every 5 minutes. The sulfo-LC-SPDP is a crosslinking agent having a functional group reactive with an amino group and is bound to the surface of fine particles on a one-to-one basis. Subsequently, 5-minute centrifugal recovery of the resulting particles was made at 20400 G, followed by washing three times with PBS by ultrasonic dispersion. After the washing, in order to permit the cleavage of the disulfide bond existing in the sulfo-C-SPDP molecule, 300 μl of DTT adjusted to 20 mM by use of PBS was added, followed by reduction reaction for 15 minutes under light-shielded conditions while subjecting to ultrasonic dispersion in every 5 minutes. Again, 5-minute centrifugation was effected at 20400 G, and pyridine-2-thione liberated from the sulfo-LC-SPDP present in the recovered supernatant liquid was subjected to absorbance determination at 343 nm. From the calibration curve, the number of amino groups present on 250 μg of the dendron-modified magnetic fine particles of the respective generations was quantitatively determined. The number of amino groups per unit particle was calculated wherein the diameter of the fine particle was taken as 80 nm. The zeta potential of the dendron-modified magnetic fine particles (0.5 μg/ml) of the respective generations, each dispersed in ultrapure water, was measured by use of a laser zeta potentiometer (ELS-8000, made by Otsuka Electronics Co., Ltd.).

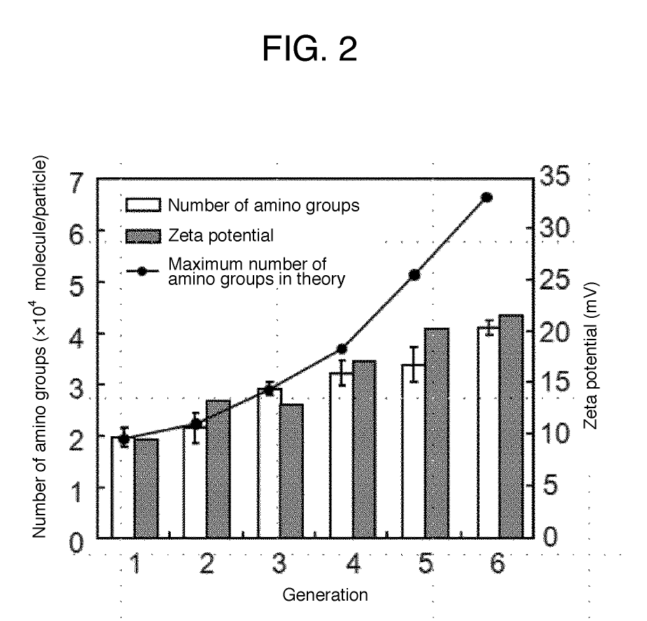

The results are shown in FIG. 2. Because the number of amino groups and the zeta potential, respectively, increase depending on the generation, it has been confirmed that the reactions proceed as expected and the dendron is fixed on individual magnetic fine particles. Dissociation was found at G5 and higher generations relative to the maximum number of amino groups in theory indicated by the black circle in the figure. This is considered due to the mutual steric hindrance of the dendron and it would be considered that when using G5 or G6 dendron, the density of the amino groups may become maximum.

Where 10 μg of dendrimer magnetic fine particles prepared by use of G4 or higher-generation dendrons were used, about 150 ng of 1DNA could be recovered. The adsorption of 1DNA relative to the number of amino groups of the G6 dendrimer magnetic fine particles was found at about 70 fg/10⁴ amines. On the other hand, with the dendrimer-modified magnetic fine particles prepared by the existing divergent method, the adsorption was at about 90 fg/10⁴ amines, revealing that the G6 dendrimer magnetic fine particles had substantially the same DNA adsorbability. In addition, the ratio of the desorption amount of 1DNA to the adsorption amount thereof when using dendrimer magnetic fine particles prepared by use of G4 and higher-generation dendrons was at about 70 to 82%, which was higher than in the case where there were used fine particles prepared by a conventional method (about 67%). In view of the above, it was proved that there could be prepared, according to the method of the invention, dendrimer-modified magnetic fine particles that had DNA recovery capability substantially equal to that of the fine particles prepared by existing methods.

What is claimed is:

1. A method for preparing dendrimer-fixed magnetic fine particles comprising the steps of:
(1) providing magnetic particles having a functional group at a surface thereof;
(2) providing a dendrimer having a functional group at a base end portion thereof and synthesized to a desired generation; and
(3) binding the functional group of the magnetic particles and the functional group of the dendrimer directly or indirectly through a crosslinking agent.

2. The method according to claim 1, wherein the functional group on the magnetic fine particles consists of an amino group and the functional group of the dendrimer consists of a thiol group, and the magnetic fine particles and the dendrimer are bound through a crosslinking agent having two types of functional groups that, respectively, react with the amino group and the thiol group.

3. The method according to claim 2, wherein the crosslinking agent has a hydroxysuccinimidyl ester group and a maleimido group.

4. The method according to claim 2, wherein the dendrimer has the thiol group that is formed by synthesizing a dendrimer to a desired generation while making use of a core having an S—S bond, and subsequently cutting off the S—S bond by subjecting to reduction treatment.
